(19) United States
(12) Patent Application Publication
(10) Pub. No.: US 2004/0105446 A1
(43) Pub. Date: Jun. 3, 2004

(54) Routing apparatus and method for guaranteeing quality of service on internet

(76) Inventors: Juyoung Park, Daejon (KR); Seok-Joo Koh, Daejon (KR); Shin Gak Kang, Daejon (KR); Dae Young Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/612,372

(22) Filed: Jul. 2, 2003

(30) Foreign Application Priority Data
Nov. 18, 2002 (KR) 2002-71656

(51) Int. Cl. H04L 12/28

(52) U.S. Cl. 370/395.21

(57) ABSTRACT

A routing apparatus for guaranteeing Quality of Service (QoS) in the Internet, includes a QoS edge routing unit for receiving a request for allocating resource from a transmitting node, setting a path at a QoS data rate by signaling; at least one QoS core routing unit for receiving a request for allocating resource from the QoS edge routing unit at a transmitter, setting a path at a QoS data rate by signaling; and a QoS edge routing unit at a receiver for receiving a request for allocating resource from the QoS core routing unit, setting a first path at a QoS data rate by signaling.

### FIELD OF THE INVENTION

The present invention relates to a routing apparatus for guaranteeing Quality of Service (QoS) on the Internet and a method therefore; and more particularly, to a routing apparatus for guaranteeing QoS in multimedia data transfer by using an existing infrastructure, a method therefore and a computer readable recording medium on which a program for implementing the method is recorded.

### DESCRIPTION OF RELATED ARTS

Generally, when data are transferred from a transmitter to a receiver, a router chooses the best path for transferring data. Data that need to be transferred at a rate enabled with Quality of Service (QoS)(hereinafter referred to as QoS rate) may not be transferred at the QoS rate because conditions of total paths connected to the router are not considered. Therefore, in case that every path is over-loaded severely, data can not be transferred at the QoS rate and equipments of network are also over-loaded.

### SUMMARY OF THE INVENTION

It is, therefore, an object of the present invention to provide a routing apparatus for guaranteeing Quality of Service (QoS) between a transmitter and a receiver by transferring data through a reserved path at a QoS data rate and a method therefore.

In accordance with an aspect of the present invention, there is provided a routing apparatus for guaranteeing Quality of Service (QoS) in the Internet, including: a QoS edge routing unit at a transmitter for receiving a request for allocating resource from a transmitting node, setting a first path at a QoS data rate by signaling for setting a path and transferring data at the QoS data rate through the first path by receiving a request for transferring data from the transmitting node; at least one QoS core routing unit for receiving a request for allocating resource from the QoS edge routing unit at a transmitter, setting a second path at a QoS data rate by signaling for setting a path and transferring data at the QoS data rate through the second path by receiving a request for transferring data from the QoS edge routing unit at a transmitter; and a QoS edge routing unit at a receiver for receiving a request for allocating resource from the QoS core routing unit, setting a first path at a QoS data rate by signaling for setting a path and transferring data at the QoS data rate through the first path by receiving a request for transferring data from the QoS core routing unit.

In accordance with another aspect of the present invention, there is also provided a routing method for guaranteeing Quality of Service (QoS) in the Internet, including the steps of: a) receiving a request for allocating resource from a transmitting node and setting a path to a receiving node at a QoS data rate by signaling of each router, a QoS edge router at a transmitter, a QoS core router and a QoS edge router at a receiver, for setting a path; and b) receiving a request for transferring data from the transmitting node and transferring data at the QoS data rate to the receiving node through the resource path reserved by the QoS edge router at the transmitter, the QoS core router and the edge router at the receiver.

In accordance with another aspect of the present invention, there is also provided a computer readable recording medium implemented in a high capacity microprocessor included in a routing apparatus for guaranteeing Quality of Service (QoS) in the Internet, including the functions of: a) receiving a request for allocating resource from a transmitting node and setting a path to a receiving node at a QoS data rate by signaling of each router, a QoS edge router at a transmitter, a QoS core router and a QoS edge router at a receiver, for setting a path; and b) receiving a request for transferring data from the transmitting node and transferring data at the QoS data rate to the receiving node through the resource path reserved by the QoS edge router at the transmitter, the QoS core router and the edge router at the receiver.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a routing apparatus for guaranteeing Quality of Service (QoS) in the Internet in accordance with the present invention;

FIG. 2 is a block diagram showing node elements in accordance with the present invention;

FIG. 3 is a flowchart showing a routing method for guaranteeing Quality of Service (QoS) in the Internet in accordance with the present invention;

FIG. 4 is a flowchart showing a QoS data transmitting process in a transmitting node in accordance with the present invention;

FIG. 5A is a flowchart showing control signaling procedures for setting a resource guaranteeing path at the QoS edge router in accordance with the present invention;

FIG. 5B is a flowchart showing control signaling procedures for setting a resource guaranteeing path at the QoS core router in accordance with the present invention;

FIG. 6A is a flowchart showing data processing procedures at a QoS end host in accordance with the present invention;

FIG. 6B is a flowchart showing data processing procedures at a QoS edge router in accordance with the present invention;

FIG. 6C is a flowchart showing data processing procedures at a QoS core router in accordance with the present invention; and

FIG. 7 is a block diagram showing a procedure for processing QoS data and general data in accordance with the present invention.

### DETAILED DESCRIPTION OF THE INVENTION

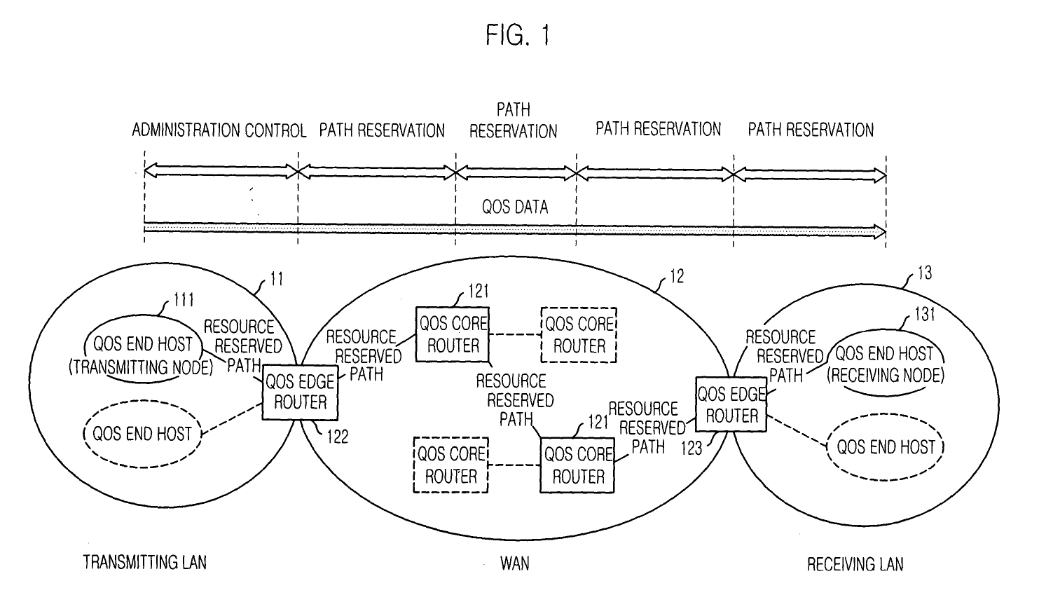

FIG. 1 is a block diagram showing a routing apparatus for guaranteeing Quality of Service (QoS) in the Internet in accordance with the present invention.

Referring to FIG. 1, the Internet has a local area network (LAN) 11 at transmitter (hereinafter referred to as a transmitting LAN), a wide area network (WAN) 12, and a local area network (LAN) 13 at receiver (hereinafter referred to as a receiving LAN). In more detail, the Internet includes a QoS end host 111 functioning as a transmitting node, a QoS end host 131 functioning as a receiving node in the Internet service, a first QoS edge router 122 that connects transmitting LAN 11 and the WAN 12, a second QoS edge router 123 that connects the WAN 12 and the receiving LAN 13, and a QoS core router 121 that connects first the first QoS edge router 122 and second QoS edge router 123.

The first QoS edge router 122 sets a path at a requested QoS data rate by using a signal for setting a path by receiving a request for allocating resource at the requested QoS rate from the transmitting node, i.e., the QoS end host. The QoS core router 121 sets a path at the requested QoS data rate by using a signal for setting a path by receiving the information of the QoS rate from the first QoS edge router 122. The second QoS edge router 123 sets a path at the requested QoS data rate by using a signal for setting a path by receiving the information of the QoS rate from the QoS core router 121.

Once setting the path is completed, the first QoS edge router 122 routes data through the reserved path at the QoS data rate from the transmitting node. Then, the QoS core router 121 routes data through the reserved path at the QoS data rate from the first QoS edge router 122. The second QoS edge router 123 routes data through the reserved path at the QoS data rate from the QoS core router 121 thereafter.

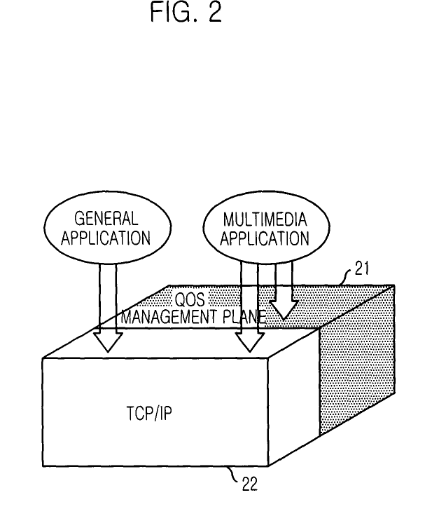

FIG. 2 is a block diagram showing node elements in accordance with the present invention.

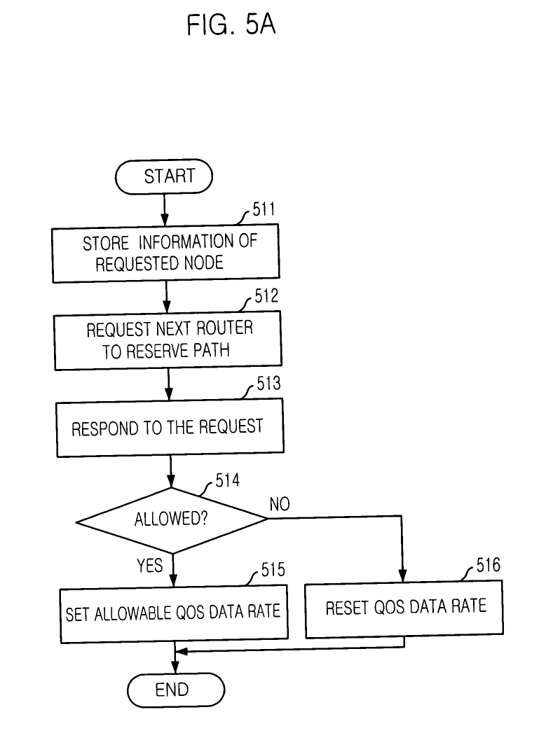

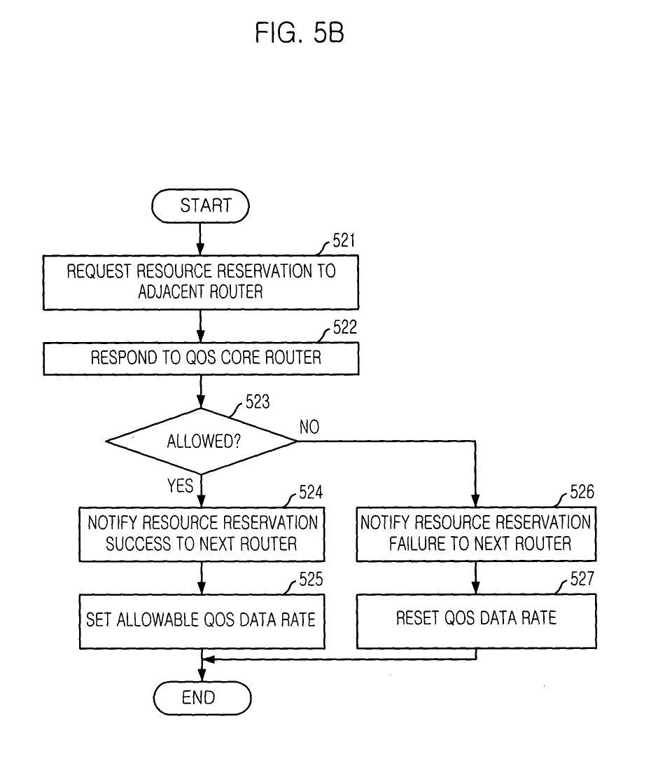

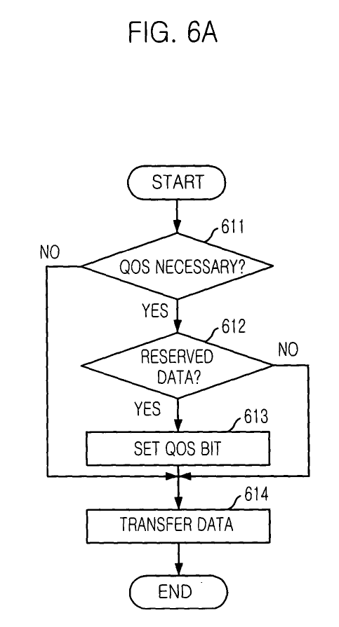

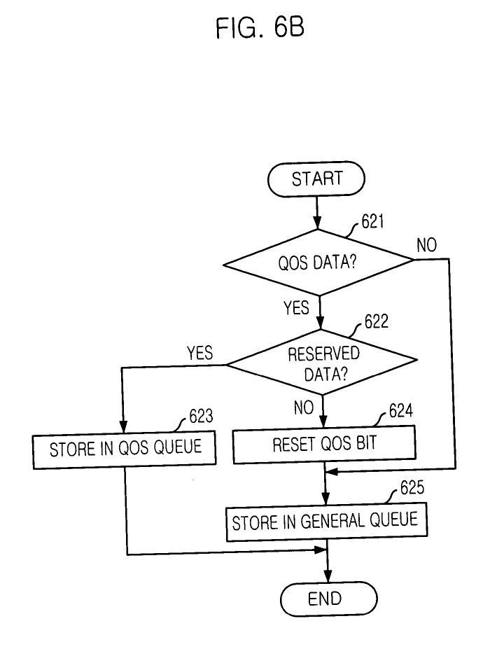

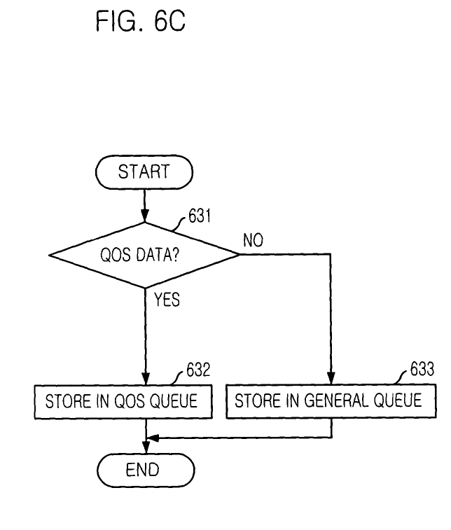

Each node includes a Transmission Control Protocol/Internet Protocol (TCP/IP) plane 22 for being used in the Internet and a QoS management plane 21 for being used to guarantee a quality of service of the Internet. A QoS end host at a transmitter, which is also called a transmitting node, separates multimedia application data and general application data. Guaranteeing quality of service is necessary for the multimedia application data and not necessary for the general application data. Also, an application that needs a guaranteed quality of service requests an end-to-end reserved path and the QoS management planes set a path by signaling. Such signaling process will be described in more detail in FIGS. 4, 5A, and 5B. The data of the application are transferred through the TCP/IP plane 22 and such management process is described in more detail in FIGS. 6A to 6C.

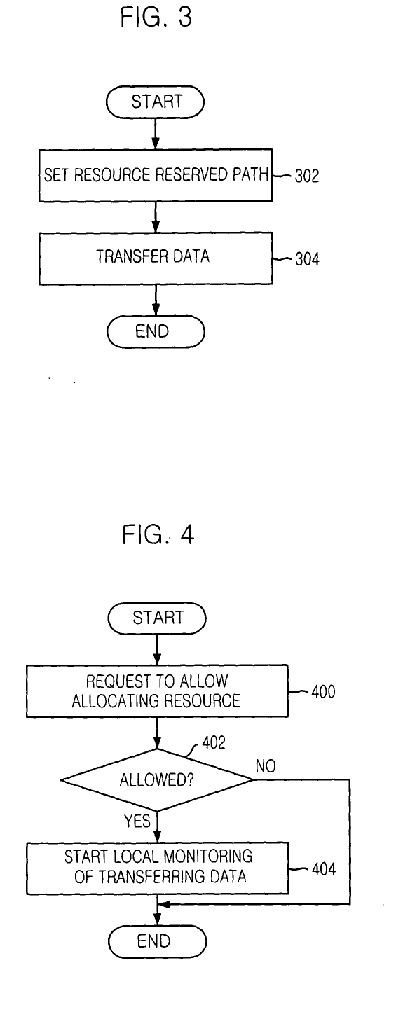

FIG. 3 is a flowchart showing a routing method for guaranteeing QoS in the Internet in accordance with the present invention.

As shown in FIG. 3, at step 302, the first QoS edge router 122 receives a request to allocate a resource at a QoS data rate from the QoS end host 111 and a resource reserved path is successfully set from the QoS core router 121 to the second QoS edge router 123. At step 304, the first QoS edge router 122 transfers data from the QoS end host 111 (hereinafter referred to as a transmitting node) to the QoS core router 121 through the resource reserved path, and then, the QoS core router 121 transfers the data from the first QoS edge router 122 to the second QoS edge router 123 through the resource reserved path. The second QoS edge router 123 transfers the data from the QoS core router 121 through the resource reserved path thereafter.

FIG. 4 is a flowchart showing a QoS data transmitting process in the transmitting node in accordance with the present invention.

The transmitting node 111 initializes a resource guaranteeing request to the QoS end host 131, i.e., the receiving node 131. At step 400, the transmitting node 111 requests to allow allocating a resource for transferring data to the QoS edge router 122 in the transmitting LAN 11. At step 402, if the resource is not allocated, the transmitting node 111 finishes the process. If the resource is allocated at step 402, at step 404, the transmitting node 111 routes data through a reserved resource.

FIG. 5A is a flowchart showing control signaling procedures for setting a resource guaranteeing path at the QoS edge router 122 in accordance with the present invention.

The QoS edge router 122 sets a resource guaranteeing path corresponding to a resource guaranteeing path request and monitors whether the transmitting node 111 transfers data as much as resource reserved by the transmitting node 111.

At step 511, the QoS edge router 122 stores node information requested by the transmitting node 111. At step 512, the QoS edge router 122 searches a path to the destination and ask the QoS core router 121 to reserve a resource corresponding to the path information. At step 513, the QoS core router 121 responds to the request of the QoS edge router 122. At step 514, the QoS edge router 122 determines whether transferring data is allowed.

Once the resource is reserved successfully, at step 515, the QoS edge router 122 sets an allowable QoS data rate for the data from the transmitting node 111. At step 516, the QoS edge router 122 resets the QoS data rate to a previous data rate or to zero.

FIG. 5B is a flowchart showing control signaling procedures for setting a resource guaranteeing path at the QoS core router 121 in accordance with the present invention.

At step 521, the QoS core router 121 requests a reservation of resource to an adjacent QoS core router or an adjacent QoS edge router according to a routing path to the destination. At step 522, the adjacent QoS core router or the adjacent QoS edge router responds to the QoS core router 121. At step 523, the QoS core router 121 determines whether transferring data is allowed. Once the resource is reserved successfully, at step 524, the QoS core router 121 notifies a success of data transfer permission to a prior router. At step 525, the QoS core router 121 sets an allowable QoS data rate. At step 526, the QoS core router 121 notifies a failure of data transfer permission to a prior router. At step 527, the QoS core router 121 resets the QoS data rate.

FIG. 6A is a flowchart showing data processing procedures at the QoS end host in accordance with the present invention.

At step 611, the transmitting node 111, i.e., the QoS end host 111 determines whether application data need QoS. As shown in FIG. 2, when general application data use the present invention, at step 614, data are transferred through Transmission Control Protocol/Internet protocol (TCP/IP). However, when multimedia application data use the present invention, at step 612, the QoS end host 111 determines whether the multimedia data exist in a reserved resource. When the multimedia data exist in the reserved resource, at step 613, the QoS end host 111 sets a QoS bit. At step 614, the multimedia application data are transferred.

FIG. 6B is a flowchart showing data processing procedures at the QoS edge router 122 in accordance with the present invention.

At step 621, the QoS edge router 121 determines whether transferred data are QoS data, wherein a QoS bit is ‘1’ for QoS data and ‘0’ for general data. In case of the general data, at step 625, data are stored in a general queue. In case of the QoS data, at step 622, data are evaluated again if data are reserved. If the data are reserved, at step 623, data are stored in a QoS queue. If the data are not reserved, at step 624, the QoS bit is reset. At step 625, data are stored in general queue.

Resource reserved data is QoS guaranteed because the transmitting node 111 and in the QoS edge router repeatedly determine whether data are reserved or not. That is, before data are transferred, data are reserved to be QoS guaranteed.

FIG. 6C is a flowchart showing data processing procedures at the QoS core router 121 in accordance with the present invention.

The QoS core router 121 does not need to estimate and manage a quantity of data. At step 631, data are evaluated simply if the data are QoS data. If the data are QoS data, at step 632, data are stored in a QoS queue. If not, at step 633, data are stored in a general queue.

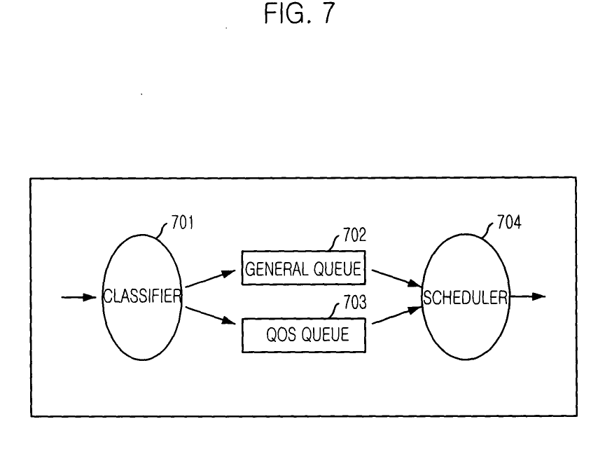

FIG. 7 is a block diagram showing a procedure for processing QoS data and general data in accordance with the present invention.

QoS data pass through a QoS queue 703 without any loss, and the general data pass through a general queue 702 with some losses according to network environment.

The method in accordance with the present invention can be saved in a computer readable medium, e.g., CD-ROM, RAM, ROM, Floppy Disk, Hard Disk, and Laser Disk.

While the present invention has been described with respect to certain preferred embodiments, it will be apparent to those skilled in the art that various changes and modifications may be made without departing from the scope of the invention as defined in the following claims.

What is claimed is:

1. A routing apparatus for guaranteeing Quality of Service (QoS) in the Internet, comprising:
a QoS edge routing means at a transmitter for receiving a request for allocating resource from a transmitting node, setting a first path at a QoS data rate by signaling for setting a path and transferring data at the QoS data rate through the first path by receiving a request for transferring data from the transmitting node;
at least one QoS core routing means for receiving a request for allocating resource from the QoS edge routing means at a transmitter, setting a second path at a QoS data rate by signaling for setting a path and transferring data at the QoS data rate through the second path by receiving a request for transferring data from the QoS edge routing means at a transmitter; and
a QoS edge routing means at a receiver for receiving a request for allocating resource from the QoS core routing means, setting a first path at a QoS data rate by signaling for setting a path and transferring data at the QoS data rate through the first path by receiving a request for transferring data from the QoS core routing means.

2. The routing apparatus as recited in the claim 1, wherein the QoS edge routing means monitors whether a quantity of data transferred from the transmitting node is smaller than the allocated resource.

3. A routing method for guaranteeing Quality of Service (QoS) in the Internet, comprising the steps of:
a) receiving a request for allocating resource from a transmitting node and setting a path to a receiving node at a QoS data rate by signaling of each router, a QoS edge router at a transmitter, a QoS core router and a QoS edge router at a receiver, for setting a path; and
b) receiving a request for transferring data from the transmitting node and transferring data at the QoS data rate to the receiving node through the resource path reserved by the QoS edge router at the transmitter, the QoS core router and the edge router at the receiver.

4. A computer readable recording medium implemented in a high capacity microprocessor included in a routing apparatus for guaranteeing Quality of Service (QoS) in the Internet, comprising the functions of:
a) receiving a request for allocating resource from a transmitting node and setting a path to a receiving node at a QoS data rate by signaling of each router, a QoS edge router at a transmitter, a QoS core router and a QoS edge router at a receiver, for setting a path; and
b) receiving a request for transferring data from the transmitting node and transferring data at the QoS data rate to the receiving node through the resource path reserved by the QoS edge router at the transmitter, the QoS core router and the edge router at the receiver.
